(19) United States
(12) Patent Application Publication
(10) Pub. No.: US 2005/0116116 A1
(43) Pub. Date: Jun. 2, 2005

(54) Wing employing leading edge flaps and winglets to achieve improved aerodynamic performance

(75) Inventor: John M. Morgenstern, Lancaster, CA (US)

Correspondence Address: KOESTNER BERTANI LLP, 18662 MACARTHUR BLVD, SUITE 400, IRVINE, CA, 92612, US

(73) Assignee: Supersonic Aerospace International, LLC, Las Vegas, NV (US)

(21) Appl. No.: 10/706,671

(22) Filed: Nov. 11, 2003

(51) Int. Cl. B64C 3/50

(52) U.S. Cl. 244/214

(57) ABSTRACT

A wing for use on a supersonic aircraft that includes an inboard section a central section of the wing outboard of the inboard portion, and an outboard section. The outboard section can be a winglet oriented anhedrally relative to a lateral axis of the supersonic aircraft. Leading edge segments on the inboard section, central section and outboard winglet may have mounted thereon leading-edge flaps. These flaps are adjusted by a control system operable to reposition the leading-edge flaps in order to improve the aerodynamic performance of the supersonic aircraft. This winglet promotes sonic boom minimization. Further, the wing tip anhedral allows greater inboard dihedral. This effectively pushes lift aft for sonic boom and control purposes while minimizing the movement of control surfaces.

### BACKGROUND OF THE INVENTION

Air travelers have long sought the convenience and efficiency of widespread supersonic commercial aviation only to be denied by technological, economic, and political roadblocks. With operations spanning over a quarter of a century, the Concorde remains the only commercial aircraft that travels at supersonic speeds but struggles with technological obsolescence. Fuel consumption and maintenance requirements of the Concorde strain commercial feasibility in today's competitive environment. Possibly overshadowing other technological and economic shortcomings is the Concorde's thunderous sonic boom that is highly annoying due to its perceived loudness and startle, a burden that restricts the Concorde's supersonic operations to primarily oceanic routes.

The sonic boom imposes many practical limitations for commercial supersonic aviation as annoyance with sonic boom loudness and startle results in the prohibition of commercial supersonic aircraft operations over most populated landmasses.

A sonic boom occurs due to pressure waves that form when an aircraft moves at supersonic speeds. As the aircraft approaches supersonic speeds, air at the leading edge of the configuration compresses to a non-linear threshold where discontinuities in flow properties, manifest through a pressure pulse and propagated through the atmosphere. Pressure pulse intensity decreases as a consequence of propagation through the atmosphere and changes shape into an N-shaped wave within which pressure rises sharply, gradually declines, and then rapidly returns to ambient atmospheric pressure. A wall of compressed air that moves at aircraft speed spreads from the wave and, in passing over ground is heard and felt as a sonic boom. Rapid changes in pressure at the beginning and end of the N-wave produce the signature double bang of the sonic boom.

Research has demonstrated that boom intensity can be reduced by altering aircraft shape, length, and weight. An aircraft that is long in proportion to weight spreads the overpressure across a greater distance, resulting in a lower peak pressure. Furthermore, wings that are spread along the body and not concentrated in the center as in a conventional aircraft have a greater lifting length and produce a pressure pulse that is similarly spread, resulting in a smaller sonic boom.

One technique for boom reduction is shaping. Shaping alters source pressure disturbance such that a non-N-wave shape is imposed on the ground. Shaping can reduce loudness by 15-20 dB or more with no added energy beyond that to sustain flight. Minimizing loudness is based on insight regarding changes in aircraft pressure disturbances during propagation to the ground. During the sixties and seventies, Jones, Seebass, Ga., and Darden developed a practical analytical guideline for low boom design.

Studies have shown that sonic boom loudness at audible frequencies correlates with annoyance. Therefore supersonic over land flight could only be achieved by reducing the sonic boom to acceptable sound levels. Shaped sonic booms are only achieved deliberately. No existing aircraft creates a shaped sonic boom that persists for more than fraction of the distance to the ground while flying at an efficient cruise altitude, since non-shaped pressure distributions quickly coalesce into the fundamental N-wave shape. Audible frequencies for a sonic boom occur wherever pressure changes rapidly, essentially at the beginning and end of a typical N-waveform. Shocks become quieter at decreasing magnitudes and increasing rise times of the pressure change. The N-wave form generates the largest possible shock magnitude from a particular disturbance. On average the front of a supersonic aircraft generates an increase from ambient pressure while the rear generates a decrease in pressure. The disturbances stretch and also coalesce because shocks travel at speeds that vary in proportion to the magnitudes of the local pressure. Higher pressures travel faster moving forward and coalescing into a single front shock, and likewise, the aft low pressures coalesce into a single rear shock. Variation in propagation speed stretches the disturbance during propagation to the ground to two to three times the vehicle length—very significant stretching. Shaped boom techniques typically attempt to prevent coalescing of the pressure disturbance by adding a large compression at the aircraft nose and an expansion at the tail with pressure between constrained to very weak compression and expansion, with correspondingly slow coalescence speeds. The shaped boom stretches the ends of the signature faster than the in-between pressures, stretching without coalescing and creating a non-N-wave sonic boom at the ground. The vehicle's pressure distribution is constrained to this particular George-Seebass-Darden shape that produces the minimum shock strength possible through the least coalescence possible.

### SUMMARY OF THE INVENTION

What are desired are wings and lift devices that facilitate sonic boom reduction and enable good off-design performance and control characteristics.

The disclosed aeronautical system teaches a wing for use on a supersonic aircraft. The wing includes an inboard section, a central section and an outboard section. The inboard and central section have sweep greater than their cruise Mach cone angle. The outboard section of the wing has a sweep lower than the Mach cone angle and a sharp leading edge. The outboard section of the wing could also be embodied as a winglet defined by a dihedral break in orientation angle relative to that of the wing dihedral angle.

In a first embodiment, the outboard lower sweep section has the same dihedral angle as the inboard portions of the wing. This embodiment shifts the aircraft's aerodynamic center and center of pressure aft. This shift aft helps achieve a minimized sonic boom according to the methodology of George-Seebass-Darden and prior patent U.S. patent application Ser. No. 10/006,505, entitled Tail-Braced Wing Aircraft and Configurations for Achieving Long Supersonic Range and Low Sonic Boom, which is hereby incorporated by reference. It also results in lower induced drag at the cruise Mach number because the outboard section can trap all the upwash generated by the inboard wing, behind the Mach cone angle but ahead of the inboard wing leading edge. This makes the outboard wing a more efficient place to generate lift than otherwise possible. Integrating this outboard with sonic boom minimization, by keeping the equivalent area less than or equal to the George-Seebass-Darden ideal equivalent area definition, allows the aft load needed for minimization to be met with less induced drag. The tip of the outboard wing may have a leading edge flap or all-moving tip for roll control with less aeroelastic effectiveness loss due to twist, especially supersonically.

The outboard lower sweep section might also have a discontinuous increase in chord and dog-toothed leading edge break. This sharp leading edge extended forward can have a leading edge flap with its hingeline aligned with the center wing round leading edge, allowing deflections of the flap to be made without steps being created with the center wing.

Another embodiment employs a winglet having anhedral of about 30 degrees, typically outboard of the fuel extent. The resulting winglet's closer proximity to the ground intensifies the ground effect increasing lift, reducing drag and resulting in improved take-off performance. Further, George-Seebass-Darden minimization requires the aircraft lift to be carried aft, and because the Mach cone angle moves farther aft the higher the lift is carried vertically, dihedral raises the height of the wing as one goes outboard. Unfortunately, too much dihedral makes the aircraft roll during sideslip. To maximize the height of the wing for sonic boom minimization without saturating roll control during sideslip, the wing should have higher inboard dihedral and an anhedraled wing tip. The tip takes advantage of its greater moment arm to counter the roll from greater inboard dihedral. By making greater inboard dihedral controllable, this anhedraled winglet improves sonic boom minimization. In addition, the winglet can capture a little more of the shock wave coming off the nacelle for drag reduction. Additional embodiments may incorporate an all-moving winglet with a rotational axis in the dihedral plane of the wing, to control roll with reduced aeroelastic effectiveness loss. This is especially true when operating supersonically. Such an all-moving winglet also results in less adverse yaw during roll conditions. High reliability actuators, like dual-tandem, can be housed in a streamwise upper surface wing bulge to avoid interference with the winglet and nacelle. Upper surface actuators with hinges located at the lower surface allow large hinge radii on the upper surface, where it is more useful for keeping control surface flow attached. The winglet incidence can be changed when the Mach number is changed from the design point to maximize drag reduction.

A third embodiment employs a winglet having a dihedral of −60 to −90 or about +90 degrees. This winglet or a portion thereof may rotate about an axis perpendicular to the plane of the inboard portions of the wing. The actuator can be placed in the axis of the wing spars. This embodiment allows increased yaw control from aft placed sideforces, and contributing drag differentials at the winglets due to the winglets or a combination of the winglets and ailerons. It could be possible to reduce or eliminate a larger center fin and rudder.

The inboard section of the wing may have a higher leading edge sweep that is adjusted to fill-in the typical dip that occurs in the equivalent area just ahead of the wing. The spanwise extent of this higher swept region can be limited to the first 20 to 30 percent of span where a leading edge flap is not typically needed, to allow for a straighter leading edge flap. This higher inboard sweep can be separate or combined with the previous outboard wing sections. A canard can also be used with or without the higher inboard sweep to fill-in the typical dip that occurs in the equivalent area just ahead of the wing.

In one embodiment, the leading-edge flap of the central section of the wing is a Krueger flap and the leading-edge flap of the outboard winglet is a simple leading-edge flap. The leading edge flaps can increase aft lift, reduce trim and vortex drag, and reduce the sonic boom signature of the supersonic aircraft. The outboard winglet can increase ground effect during take off and can provide positive wave drag interference with the nacelle. The leading edge flap of the outboard winglet can also provide roll control at supersonic conditions and directional control with proverse roll effects. Some embodiments may further include trailing-edge flaps on one or more sections, wherein the leading edge flaps are controlled in conjunction with the trailing edge flaps to reduce drag while cruising subsonically. Additionally, the control system coupled to the leading-edge flaps can adjust the leading-edge flaps to improve aerodynamic flow fields for flight at Mach numbers different from the Mach number to which the aircraft design is optimized.

Another embodiment more specifically claims an aircraft wing capable of coupling to an aircraft fuselage and having a leading edge, the wing extends inboard to outboard. A strake couples to the aircraft fuselage and extends to the leading edge of the wing. In some embodiments the strake further includes a leading-edge flap. A Krueger flap couples to the leading edge of an inboard portion of the wing adjacent the strake. If present, the strake leading-edge flap operates as a leading-edge device to create an airflow field impinging on the Krueger flap to reduce or eliminate inboard vortices in an upper surface airflow field. The outboard winglet may have a simple leading edge flap coupled to its leading edge, wherein the outboard winglet is anhedrally oriented relative to a lateral axis of the aircraft, and wherein its leading edge flap provides roll control and directional control for the aircraft.

The wing and strake form a swept wing that extends with at least one sweep angle from the fuselage. In fact, the wing and strake may form a swept wing that extends in a plurality of sweep angle segments from the fuselage. The sweep angle of the inboard portion of the wing differs from the sweep angle of the strake and outboard winglet. As in the previous embodiment, the outboard winglet increases ground effect during take off provides positive wave drag interference with the nacelle. The wing may further employ trailing-edge flaps on one or more sections, wherein the leading edge flaps are positioned in conjunction with the trailing edge flaps by a control system to reduce drag at subsonic cruise conditions. By themselves, the leading edge flaps increase aft lift, reduce trim and vortex drag, and reduce the sonic boom signature of the supersonic aircraft. Furthermore, the control system coupled to the leading-edge flaps allows the flaps to be adjusted to improve aerodynamic flow fields for flight at Mach numbers different from the Mach number to which the aircraft design is optimized.

Wing control surfaces, flaps, tails and canards can be used to meet sonic boom minimization requirements. By using movable surfaces to alter the lift distribution to meet sonic boom minimization requirements, resulting drag penalties do not have to be incurred wherever low sonic boom is not required, like over water. Since maximum range is generally most important over water, using movable surfaces for sonic boom minimization can reduce the drag penalty associated with reducing sonic boom.

### BRIEF DESCRIPTION OF THE DRAWINGS

Embodiments of the invention relating to both structure and method of operation may best be understood by referring to the following description and accompanying drawings.

FIG. 1 provides a pictorial diagram of an aircraft employing the teachings of the disclosure;

FIGS. 2A-2G are schematic pictorial diagrams respectively illustrating side, top, and three-dimensional perspective views of an embodiment of an aircraft leading-edge flap;

FIG. 3A-3C depict embodiments of the wing used with the disclosed airfoil;

FIG. 4 provides a head on view of an aircraft employing the teachings of the disclosure;

FIG. 5 is a schematic pictorial diagram that illustrates an example of a leading edge flap for usage in the aircraft lift device shown in FIG. 3;

FIGS. 6A and 6B are schematic pictorial diagrams showing embodiments of different airfoil planforms;

FIGS. 7A-7C depict different airfoil planforms;

FIGS. 8A-8D depict pictoral and cross sectional views of one Krueger Flap arrangement;

FIGS. 9A-9C are schematic pictorial diagrams respectively depicting side, front, and top views of a supersonic aircraft that can utilize the illustrative lift devices;

FIGS. 10A, 10B, 10C, and 10D are a series of graphs that illustrate theory upon which a low sonic boom signature is attained by controlling the leading edge flaps of the wings; and

FIG. 11 is a graph that further illustrates theory of equivalent area minimization to reduce sonic boom signature, showing effective area against axial location along the longitudinal axis of the aircraft;

FIG. 12 depicts how the winglet may be used to achieve roll control.

FIG. 13 depicts how the winglet may be utilized to achieve directional control.

FIG. 14 is a graph of the equivalent area due to lift versus axial location; and

FIG. 15 illustrates the various repositionable aerodynamic surfaces

### DETAILED DESCRIPTION OF THE EMBODIMENTS

Preferred embodiments of the present invention are illustrated in the FIGUREs, like numerals being used to refer to like and corresponding parts of the various drawings.

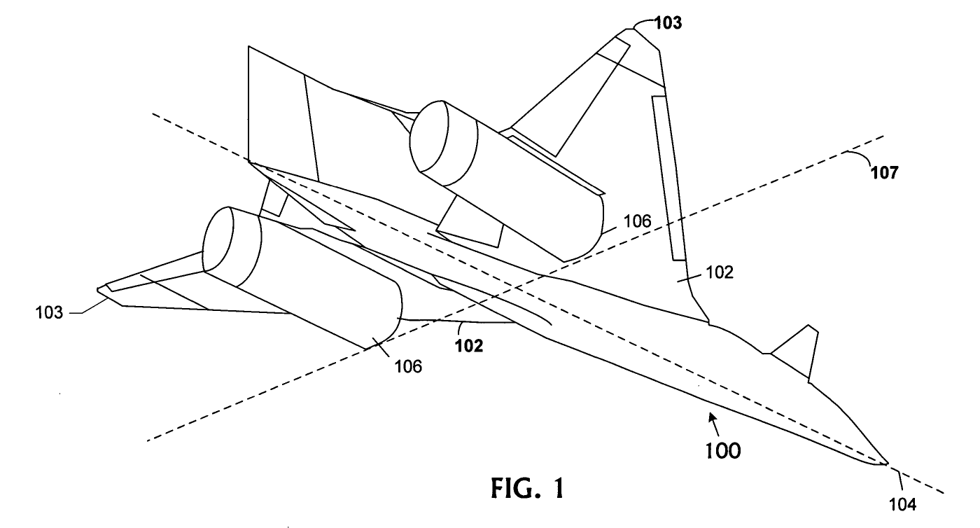

FIG. 1 illustrates an example of an aircraft 100 having a longitudinal axis 104 forward and aft to which an airfoil is coupled. Airfoils are generally designed to maximize aerodynamic performance at a particular Mach number or range of Mach numbers. In various circumstances and conditions, operation at off-design Mach numbers is desirable. The airfoil includes aircraft wings 102. However, the airfoil may also include other aerodynamic shapes including the fuselage, tail, and other structures within the air stream. Wings 102 further include winglets 103.

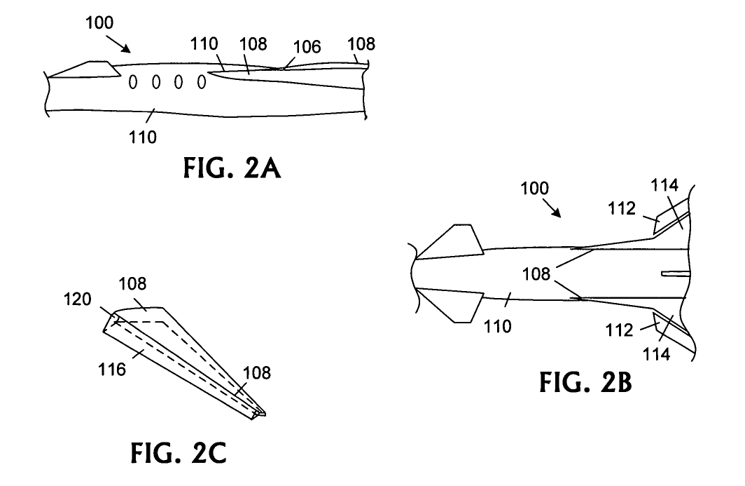

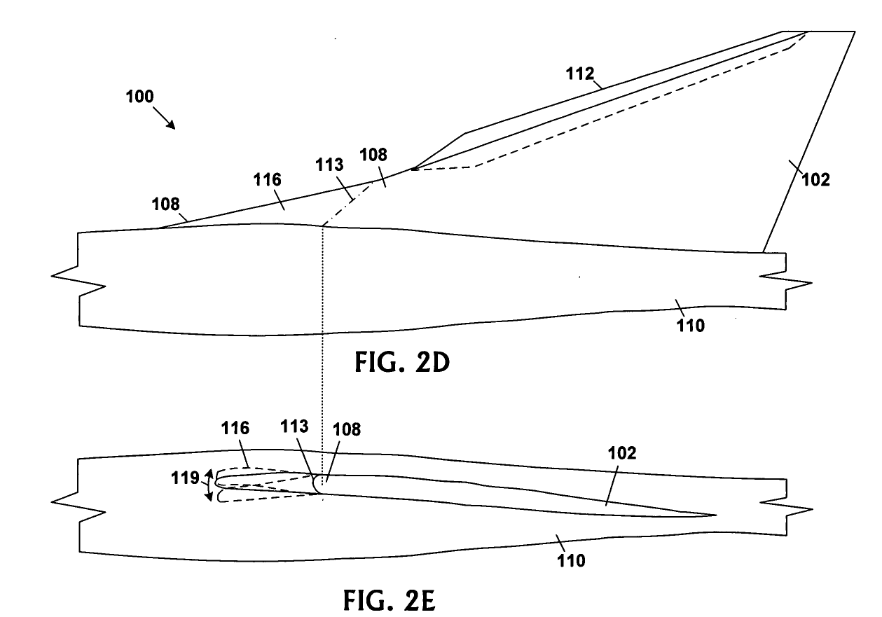

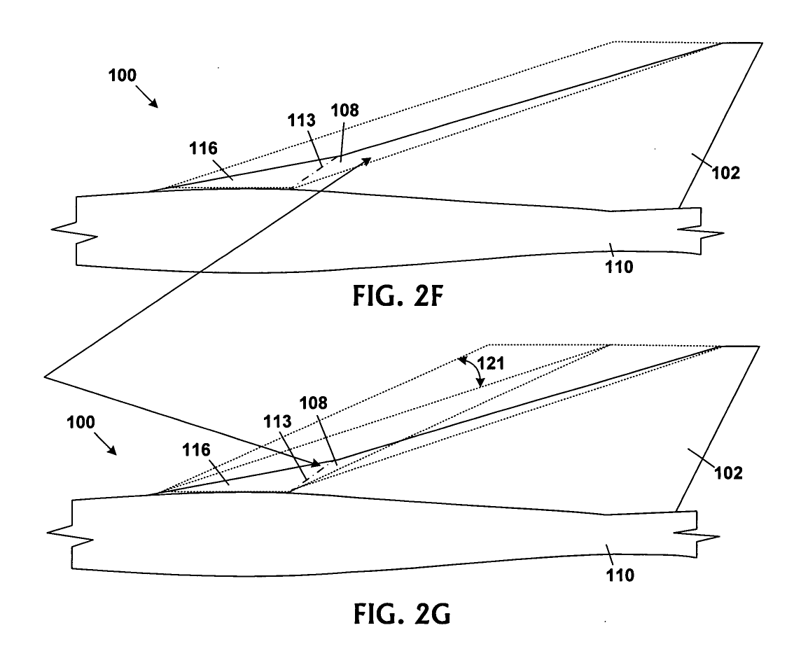

FIGS. 2A, 2B, and 2C illustrate side, top, and three-dimensional perspective views of an embodiment of portions of wings for usage on aircraft 100. Wings 102 couple to a strake 108 that couples to aircraft fuselage 110 and extends along a portion of the aircraft fuselage 110 to leading edge 112 of wings 102. Strake 108, generally a small aspect ratio lifting surface with large sweep angles, typically functions as a vortex lift generator. A leading-edge flap 116 may be coupled to the strake leading edge 118. However, this leading edge flap is not necessary in all embodiments. If present, strake leading-edge flap 116 can extend over a portion of the length of strake 108 or can extend the full span of strake 108. As shown in FIG. 2C, strake leading-edge flap 116 is a simple or plain flap. In the simple flap, a portion of the leading edge 118 can have a hinged pivot 120 or can be driven by a wheel on rail type of mechanism as in commercial jets. The pivot or other moveable structure enables a surface of strake leading-edge flap 116 to move or extend downward. Leading-edge flap 116 can be controlled to improve aerodynamic flow fields for flight at Mach numbers different from the Mach number to which the aircraft design is optimized. Operation of the strake leading edge flap improves aerodynamic performance at off-design conditions. Strake leading-edge flap 116 can also reduce lift ahead of spillage at an off-design condition and maintain a low sonic boom signature.

In the embodiment depicted, strake 108 typically functions as a leading edge flap device configured to function as a subsonic leading edge even at supersonic conditions and a vortex lift generator positioned in front of the leading edge of wing 102. Wing 102 typically has a smaller sweep angle and a larger aspect ratio than strake 108. Strake 108 creates spiral vortices by separating flow at its leading edge 118. Flow reattaches on the wing' upper side, producing a nonlinear lift due to depression on strake 108 and on portions of wing 102.

Strake 108 or a portion thereof functions as a leading edge device that in some embodiments can be controlled to improve aircraft performance and utility. For example, strake leading-edge flap 116 can be controlled to adjust the airflow fields around wing 102 and airfoil at different air speeds. For a wing 102 designed to optimize aerodynamic performance at a particular Mach number or range of Mach numbers, for example 1.6 to 1.8, the leading-edge flap 116 can adjust aerodynamic flow fields to the actual Mach number during flight. In a specific example, if a wing is designed for optimal aerodynamic performance at Mach 1.6 and airspeed of Mach 1.8 is desired, strake leading-edge flap 116 can be adjusted to produce flow fields to optimize the airfoil for Mach 1.8 conditions. Flow fields are most affected by airfoil shape and form at the leading edge, which sets the form of the downwash on wing 102. Accordingly, strake leading-edge flap 116 optimizes airfoil effective shape to adjust the optimum Mach number of the aircraft. Additionally, the strake can be deflected up or down to control the aircraft's sonic boom signature, to manage or reduce air spillage and also to improve drag when flying at off-design Mach conditions.

Referring to FIGS. 2D and 2E, pictorial diagrams respectively show bottom and side views of embodiment of a leading edge strake flap 116, particularly showing a swept hinge line 117 of the strake flap 116. The swept hinge line 113 enables strake flap rotation without unsealing the flap 108 from the fuselage 110. FIG. 1E depicts the range of motion 119 of the leading edge strake flap 116.

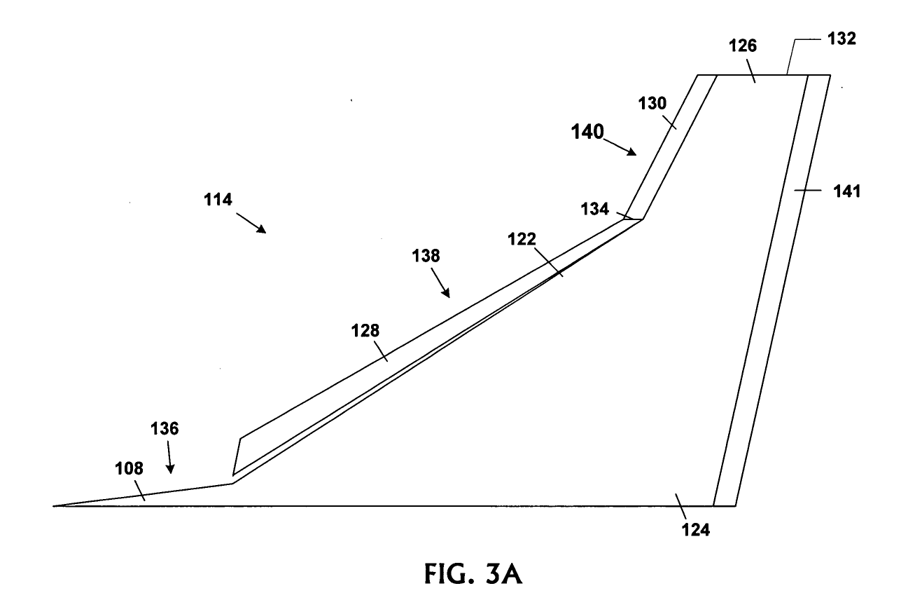

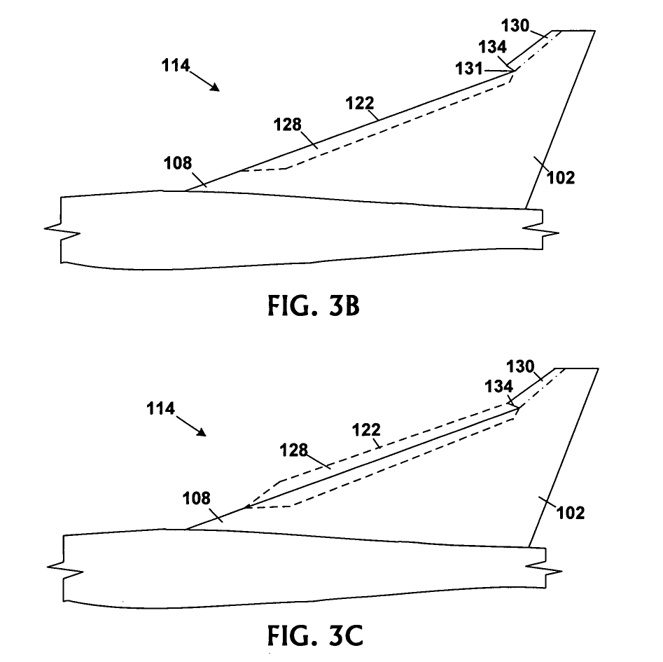

Referring to FIGS. 2F and 2G, schematic pictorial diagrams show top views of an embodiment of the leading edge strake flap 116 to illustrate aerodynamic influence of the flap 116 in operation. As Mach number is reduced, as shown in FIG. 2G in comparison to FIG. 2F, the leading edge flap's influence moves ahead of the wing, shown by movement 121. Therefore, the optimal deflection of the leading edge strake flap 116 tends to change when Mach changes. In addition, sonic boom lift distribution constraints tend to benefit from deflection. From another perspective, flight not constrained for sonic boom has a reduced drag penalty when the strake leading edge flap 116 is deflectable. The outboard section can trap all the upwash generated by the inboard wing, behind the Mach cone angle but ahead of the inboard wing leading edge. This makes the outboard wing a more efficient place to generate lift than otherwise possible. Integrating this outboard with sonic boom minimization, by keeping the equivalent area less than or equal to the George-Seebass-Darden ideal equivalent area definition, allows the aft load needed for minimization to be met with less induced drag. FIGS. 3 and 3B further teach such wingtips.

FIG. 3A depicts wing 102 in further detail. Aircraft wing 102 mounts onto aircraft fuselage 110. Leading edge 122 extends along the wing inboard 124 to outboard 126. Strake 108 couples to aircraft fuselage 110 and extends from the fuselage to leading edge 122. As shown, leading edge 122 comprises a Krueger flap 128 outboard of strake 108 and inboard of a simple flap 130. Krueger flap 128 and simple flap 130 generally have different leading edge structures. The Krueger flap may extend over a range of leading edge 122 and functions o reduce vortex drag at supersonic cruise speeds, increase aft lift, and reduce trim drag while providing a reduced sonic boom signature. Generally, leading edge flaps bend or extend a surface downward along a forward portion of the wing. The entire leading edge may be a single structure or may have multiple leading edge segments with leading edge flaps of various types as known to those skilled in the art. For example, in some embodiments, Krueger flap 128 can extend from strake 108 to the wing tip. Krueger flap 128 couples to leading edge 122 at a relatively inboard portion of the wing adjacent strake 108. Simple leading edge flap 130 couples to leading edge 122 of wing 102 and extends from junction 134 with Krueger flap 128 to outboard winglet 132. Strake leading-edge flap 116 operates as a leading-edge device that, for subsonic performance, deflects to create an airflow field impinging on Krueger flap 128 so that the upper surface airflow field reduces or eliminates inboard vortices.

Wing 102 and strake 108 are both arranged at a sweep angle from the fuselage and form a swept wing that extends at a sweep angle from the fuselage. As depicted, wing 102 and strake 108 are configured with different sweep angles to form a swept wing that extends in a plurality of sweep angle segments 136, 138, and 140 from the fuselage. For example, the sweep angle of wing 102 differs from the sweep angle of strake 108. Furthermore, the sweep angle of wing segment 138 inboard of junction 134 can differ from the sweep angle of wing segment 140 outboard of junction 134. In other embodiments, the sweep angles may be the same for wing 102 and strake 108. Outboard section 40 may partially trap the upwash generated by inboard segments 136 and 138.

Referring to FIGS. 3B and 3C, schematic pictorial diagrams show top pictorial views of an embodiment of an aircraft lift device with a Krueger flap 128 in respective non-deployed and deployed positions. As shown in FIG. 3B, with the Krueger flap 128 in the retracted position, the leading edge 122 transitions inboard to outboard along the retracted Krueger flap 128 to the junction with the leading edge plain flap 130. The intersection between the retracted Krueger flap 128 and the leading edge plain flap 130 forms a sharp leading edge angle (or discontinuous increase in chord), termed a dog-toothed arrangement 131. As shown in FIG. 3C, the deployed Krueger flap 128 meets and-seals with the deflected outboard leading edge plain flap.

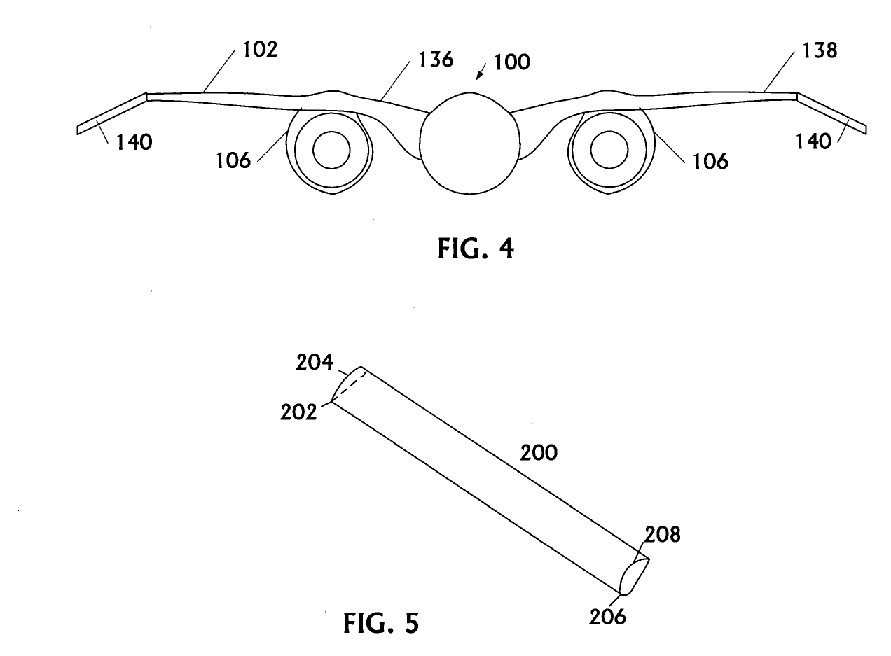

Not only may the sweep angle of the segments differ, the dihedral angle of these segments may differ as well. For example, the dihedral angle of the segment outboard of junction 134 may be negative or anhedral. As previously discussed an anhedral of about 30° provides improved roll control. An anhedral of about 90° provides improved directional control. In either case, the ground effect may be enhanced to provide improved take-off performance. In this instance, wing 102 takes on a gull like profile with outboard winglet 140 inclined downward from the lateral axis of the aircraft. This profile is depicted in FIG. 4. Here, segment 136 has a positive dihedral angle relative to the aircrafts lateral axis. Segment 138 is approximately parallel to the aircraft's lateral axis. Segment 140, which in this embodiments comprises winglet is anhedrally oriented relative to the aircraft. Anhedral segment 140 increases directional stability and control, increase the ground effect during takeoff, and provides positive wave interference with the nacelles 106.

Modifying wing tip flow with outboard winglets alters the trailing tip vortex produced by an aircraft wing and enhances the aircraft's overall performance. Winglets take advantage of the strong sidewash that occurs at the wing tip. This sidewash meets the winglet at an angle of attack and produces a side force. From this the winglet forms its own horseshoe vortex system. The winglet vortex system partly cancels the wing tip vortex at the wing-tip/winglet junction and therefore the main tip vortex now forms at the tip of the winglet. By moving at the tip vortex out of the plane of the main wing with the anhedral orientation of the winglet relative to the aircraft's lateral axis, the downwash over the wing's surface can be substantially reduced. This has the advantage of reducing the induced drag. In addition, the side force produced on a winglet when resolved, provides a forward thrust component or negative drag. These two effects more than offset the parasitic drag produced at the winglet junctions and thus provide a beneficial effect on the overall drag of the aircraft. In addition to providing aerodynamic efficiency and both roll and directional stability and control, the control surfaces on the winglet in the form of leading or trailing edge devices allow the position of the aerodynamic center of the aircraft to be actively controlled during supersonic flight with minimal control surface deflections. This further aids in minimizing trim drag.

In operation, leading edge flaps, including Krueger flaps and simple edge flaps, extend for low speed operations during takeoff, approach, and landing. In a particular example, leading edge flaps can be extended up to and beyond 130 degrees to improve lift-to-drag ratio in a range around 1.5 to 2.5, resulting in better climb performance, and reduced takeoff and landing field length. Additionally, leading edge flap devices on the outboard winglet can provide a measure of roll control at supersonic speeds and directional control with proverse roll effects.

FIG. 4 depicts a front profile of aircraft 100 with anhedral outboard winglet 132. The inboard portion of the wing may comprise about 85% of the wing span and does not require a negative dihedral. Leading edge 122 has incorporated therein leading edge flap devices which are controlled to reduce the vortex and trim drag of the wing at supersonic cruise and increase at lift for the boom while providing a low boom signature. The anhedral orientation of the winglet increases directional stability and increases the ground effect during take-off as well as providing positive wave drag interference with nacelles 133.

Leading edge devices may be used in conjunction with trailing edge devices to reduce drag at subsonic cruise conditions. The use of the leading edge flap in conjunction with a trailing edge may reduce drag. In addition, the leading edge flaps on winglet 132 may be used for roll or directional control. The anhedral angle of winglet 140 depends on the specific configuration as there is an optimal combination of wave drag reduction at supersonic cruise and increased lift at take off, as well as directional stability. These three factors influence how much anhedral or downward inclination of the winglet there is in relation to the aircraft's lateral axes. This relation may be predicted or empirically determined by the desired combination of properties to be exhibited by the supersonic winglet.

FIG. 5 illustrates one embodiment of leading edge flap 130. As shown, leading edge flap 130 is a simple leading edge flap having a cross-sectional form transitioning from a sharp or pointed form 202 at the outboard end 204 to a rounded form 206 at Krueger flap junction 208. The variable form of leading edge flap 130 from the outboard sharp point transitioning to a more rounded form in the inboard direction to a junction with the Krueger flap reduces or minimizes sharp edges or gaps in the wing leading edge. Some aircraft embodiments may omit the simple flap in favor of a Krueger flap(s), or other similar device know to those skilled in the art, that extends to the wing tip.

Leading edge flap 130 at the outboard end 204 can have varying degrees of sharpness or pointed character. In general, leading edge flap 130 transitions from an edge with a relatively small radius of curvature at the outboard end 204 to an edge with a relatively larger radius of curvature at the inboard end a the Krueger flap function 208.

Although, leading edge flap 130 is depicted as a simple leading edge flap, combinations of other types of flaps can be used. For example, some arrangements can use a split flap in the span wise direction, in which a hinged portion of the bottom surface of the wing can be extended to increase the angle of attack by changing the chord line. In other configurations, a Fowler flap can be used that, when extended, both tilts downward and also slides rearward. In other systems, a slotted flap may be used that, in addition to changing the wing camber and chord line, also allows some high-pressure air beneath the wing travel through the slot. Other embodiments can use any other suitable type of flap. Furthermore, some embodiments, for example configurations in which the leading edge is subsonic, may omit usage of the leading edge flap.

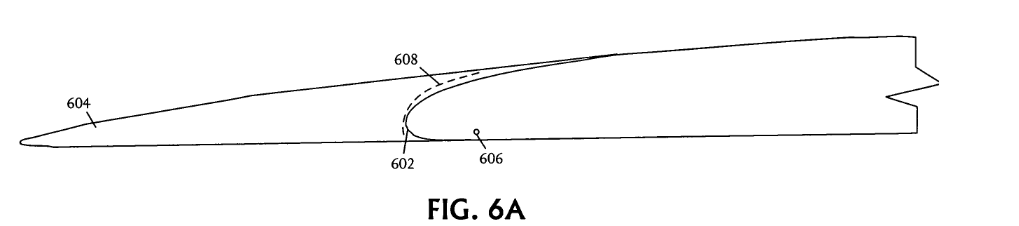

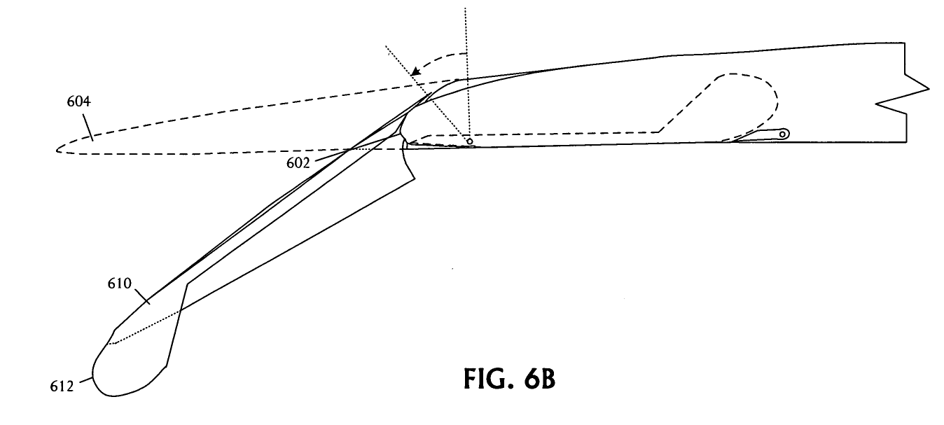

FIGS. 6A and 6B provide cross-sectional partial airfoil views showing the transition from the inboard to outboard leading edge. FIG. 6A illustrates the transition from a round inboard leading edge 602 to the outboard dog-toothed, sharp leading edge flap 604. As shown, sharp leading edge 604 can have a leading edge flap wing with a hinge line aligned with center section round leading edge 602. The sharp plain leading edge flap 604 pivots about a pivot point 606 along a hinge line 608. Also shown is a portion of the wing under the flap surface. This arrangement allows defections of the flaps to occur without creating steps or discontinuities in the wings leading edge.

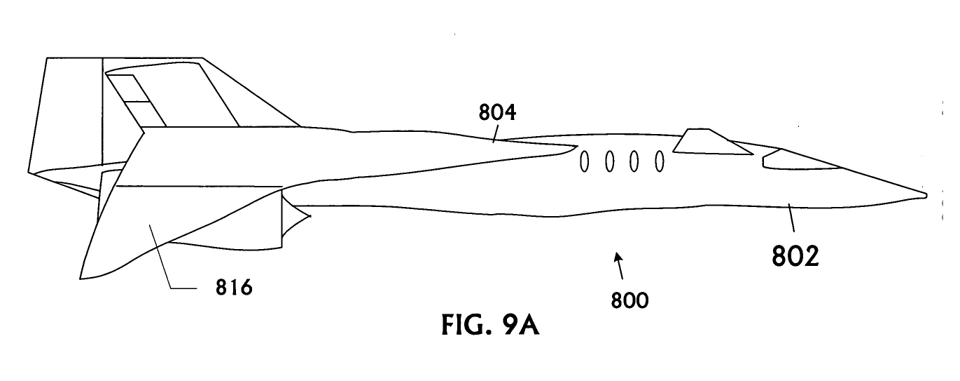

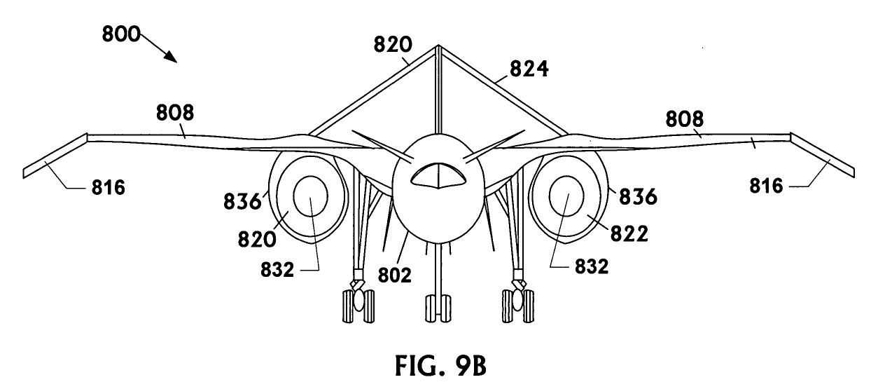

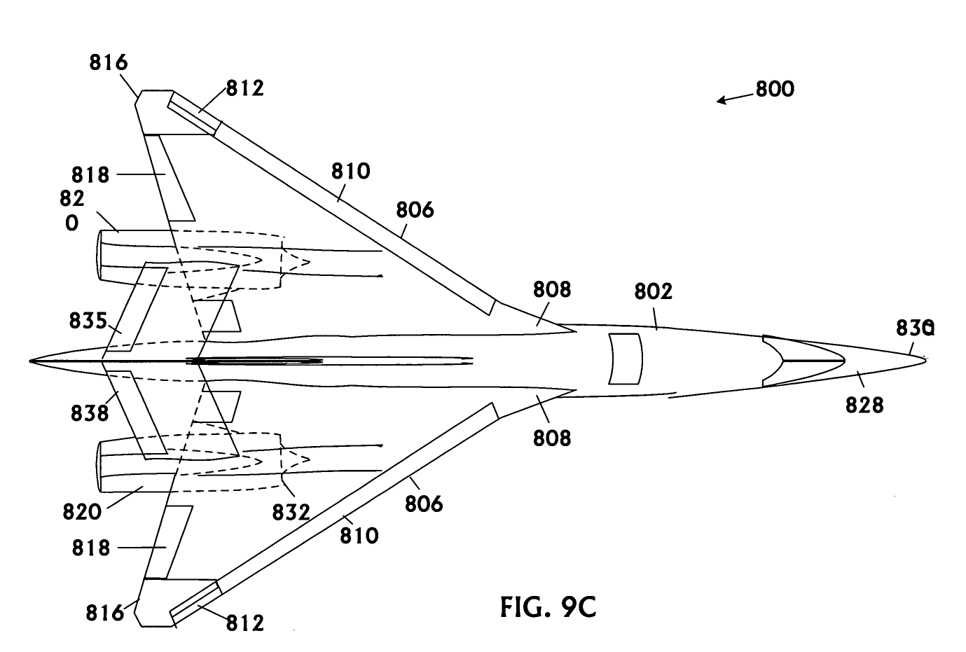

As the Mach cone angle moves farther aft the higher the lift is carried vertically, dihedral raises the height of the wing as one goes outboard. However, too much dihedral makes the aircraft roll during sideslip. To maximize the height of the wing for sonic boom minimization without saturating roll control during sideslip, the wing should have higher inboard dihedral and an anhedraled wing tip. As shown in FIG. 9B, winglet 816 takes advantage of its greater moment arm to counter the roll from greater inboard dihedral. By making greater inboard dihedral controllable, this anhedraled winglet improves sonic boom minimization Additionally, winglet 816 typically outboard of the fuel extent allowing the fuel bearing portion of the wing 808 to be flat or dihedraled easing pumping fuel, and allows movement as a control surface. This much smaller, lower sweep outboard winglets 816 works without negatively impacting fuel volume and bending loads as much.

FIG. 6B shows the transition from the round Krueger flap 610 to the dog-toothed, sharp plain leading edge flap 604. Krueger flap 610 has a round leading edge radius 612 that gradually blends to a sharp edge moving inboard to outboard along the leading edge 602. The gradual tapering from rounded to sharp of the Krueger flap leading edge encourages attached flow and thereby lowers drag.

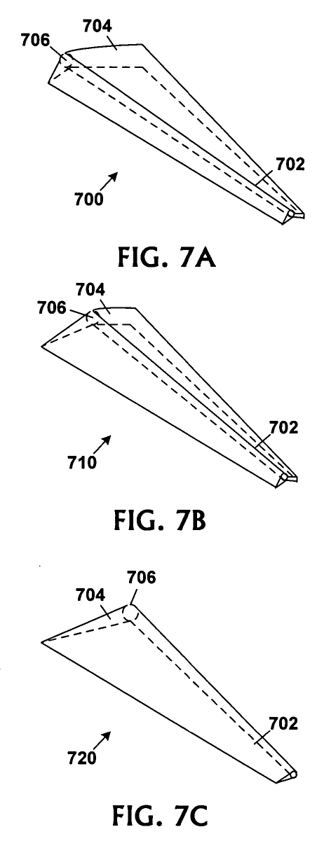

Referring to FIGS. 7A, 7B, and 7C, schematic pictorial diagrams show various planform embodiments of aircraft lift devices 700, 710, and 720, respectively. In various embodiments, an aircraft lift device comprises a simple leading-edge flap 702 mounted to a strake 704 of a highly swept leading edge supersonic planform. The supersonic planform includes a wing and a body, also called a fuselage. Leading-edge flap 702 may include the entire strake 704 and sweeps about a body junction. The hinge line or pivot 706 may vary from a direction that is orthogonal to the fuselage to a configuration that is parallel to the strake leading-edge.

The leading-edge device 700, 710, 720 are used to soften the sonic-boom signature for a given supersonic configuration and/or improve aerodynamic performance, in other words lower drag, at off design conditions such as lower or higher cruise Mach numbers. If a Krueger flap is used as a leading-edge device for subsonic performance the leading-edge strake device, when deflected, facilitates formation of a favorable flow field for the Krueger flap so that the upper surface flow field is substantially free from inboard vortices. A smooth transition of simple leading-edge flap device to a Krueger flap similarly assists in avoidance of inboard vortices.

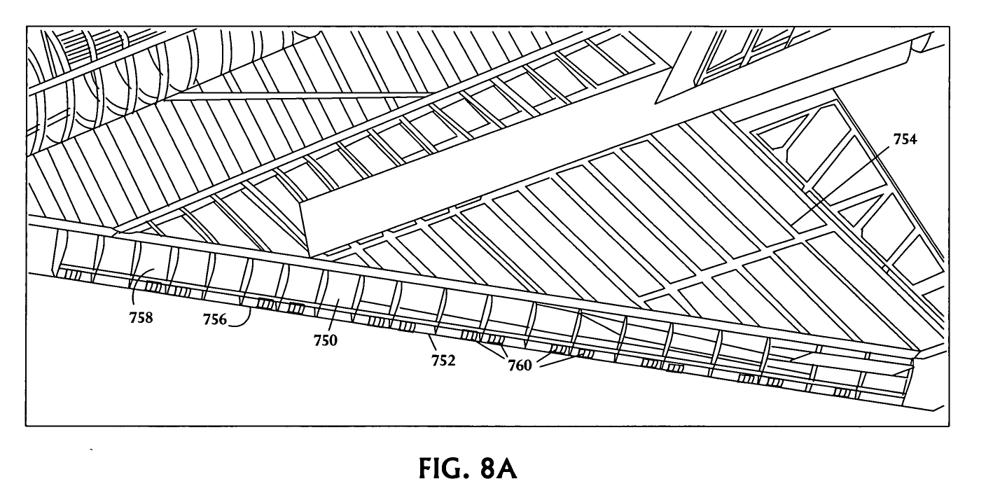

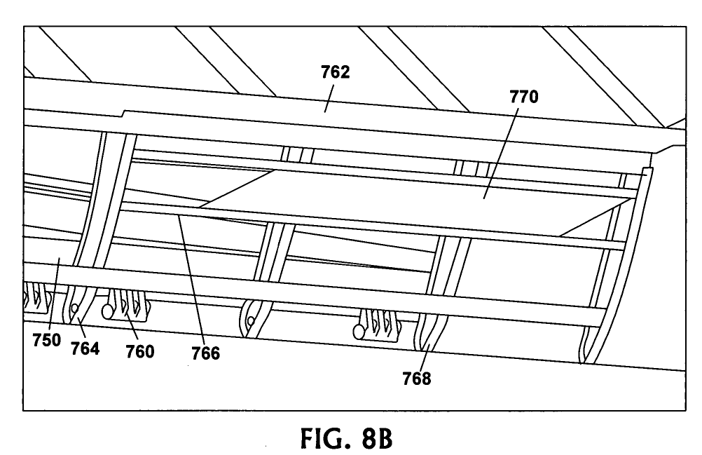

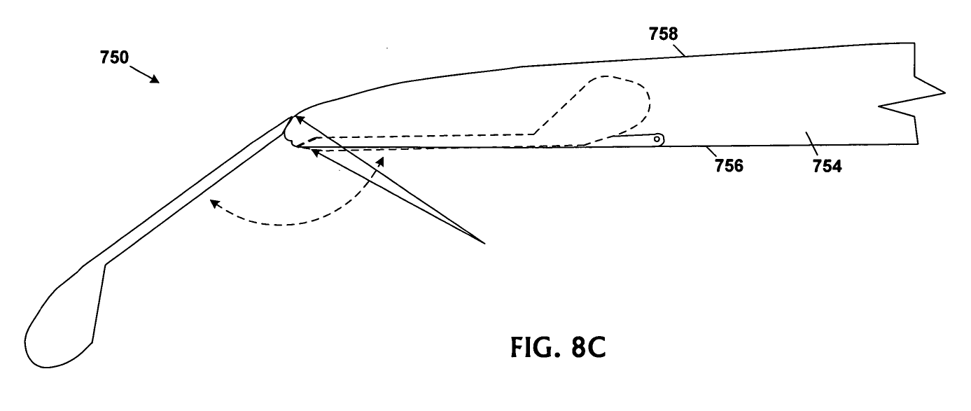

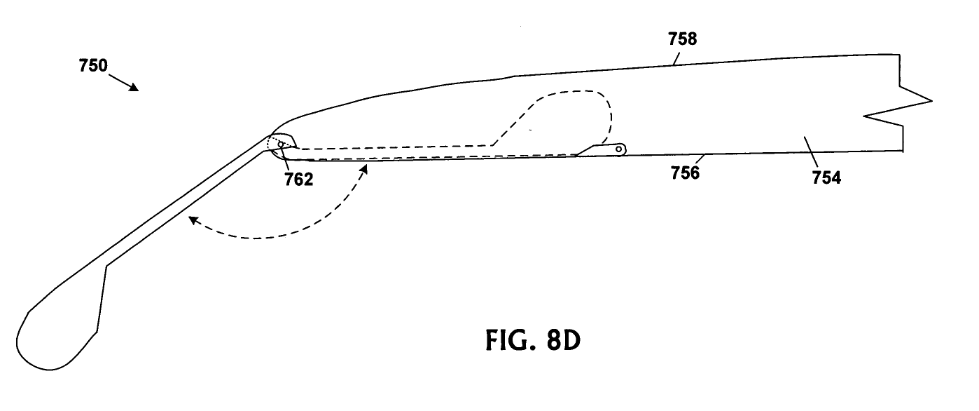

FIGS. 8A and 8B provide schematic diagrams showing one embodiment of a Krueger flap 750. Krueger flaps 750 are aerodynamically-effective movable components on the leading edge of the airfoil. These high-lift devices supply additional lift in certain configurations and under certain flight attitudes. Krueger flaps 750 are connected to the leading edge 752 of the wing 754 and extend from lower surface 756 to increase lift capability during low-speed operation. High-lift devices, such as Krueger flaps 750, facilitate lift-off and landing at low speeds, and maintain undisturbed wing root airflow over the wing upper surface 758 without separation at the transition from fuselage to wing.

In one embodiment, leading edge Krueger flaps 750 include two surfaces, inboard and outboard, which rotate out 145°. The surfaces are driven by rotary actuators 760, with multiple slices connected to each panel. The slices are interconnected with torque tubes, and the entire assembly is driven by a central power drive unit (PDU). The PDU may be located in the wing root area. A position sensor and an asymmetry brake are located on the outboard end of the rotary actuator assembly.

From the stowed position, rotary actuators 760 may rotate Kruger flap 750 downward and forward from the lower surface 756 of the wing 754. As shown, Krueger flap 750 depicts one type of a suitable rotary actuator 760 suitable for usage on a wing or other airfoil. In general, any Krueger flap with appropriate configuration, aerodynamic configuration, and actuating mechanism can be used. Generally, a suitable Krueger flap has an actuating mechanism capable of forming the wing leading edge configuration into a rigid airfoil structure at multiple different operating positions maintaining short and efficient load paths. Furthermore, a suitable Krueger flap has a control linkage mechanism that is stable at the different operating positions and deflects downward when actuated through a range of selected rotational angles while maintaining a substantially smooth wing surface with an aerodynamic, relatively constant radius of curvature. The actuating linkage operates to controllably stow and deploy the flap 750 during takeoff and landing, and for usage as a speed brake, if desired, during either high or low-speed in-flight operating conditions..

FIG. 8B shows a close-up view of a portion of the Krueger flap 750 in greater detail. Details shown include a left wing front spar 762, left Krueger flap hinge point 764, a flight spoiler hinge beam 766, left leading edge rib 768, and left outboard flight spoiler 770.

Referring to FIGS. 8C and 8D, pictorial cross-sectional partial airfoil views show two embodiments of Krueger flap arrangements. FIG. 8C shows an embodiment of the Krueger flap 750 in which the location of the Krueger flap 750 on the wing lower surface is chosen so that the curvature of the upper wing surface 758 matches the Krueger flap curvature for a desired deflection. The matched curvature increases or maximizes the radius at the transition from flap 750 to wing 754, maintaining flow attachment to wing 754 to result in lower drag. Krueger flap 750 attaches wing 754 below the stagnation point and thereby does not disturb laminar flow on upper surface 758.

FIG. 8B shows an alternative embodiment of a Krueger flap 750 that is simplified, having a single pivot point 762, in comparison to the flap shown in FIG. 8C.

FIGS. 8A through 8D in combination with FIG. 4, the rounded form 208 of the inboard portion of the leading edge flap 200 smoothly transitions to the form of the Kruger flap at the Krueger flap junction to reduce or minimize any gap in the wing leading edge.

Returning to FIG. 3, leading edge 122 of wing 102 is configured so that the shape of the leading edge flap 130 merges into the form of Krueger flap 128. In particular, the structure and configuration of the leading edge flap 130 and Krueger flap 128, are arranged so that when Krueger flap 128 is deployed, airflow separation over wing 102 is reduced or minimized. The cross-sectional morphology of the leading edge flap 130 matches Krueger flap 128 to avoid structural discontinuities, protrusions, or gaps that can create a vortex at a position along leading edge 122, such as at the junction 134. Vortices formed at the top of wing 102 corrupt the flow field. Leading edge flap 130 avoids flow field corruption via usage of rounded edges and structures in Krueger flap 128 and the leading edge flap 130, particularly in the vicinity of the junction.

In various embodiments, junction 134 between the leading edge flaps can have some structural discontinuity. A structural element that smoothes the transition between segments can be used to improve aerodynamic performance. This structural material can be a flexible material such as rubber, plastic, a synthetic, or other like materials known to those skilled in the art.

The particular structure of Krueger flap 128 and the leading edge flap 130 can vary depending on the wing configuration. For example, leading edge 122 may be either a subsonic or supersonic leading edge. When leading edge is contained within the Mach cone of the aircraft, structural discontinuities, protrusions, and gaps are to be avoided. However, when the leading edge is outside the Mach cone, the leading edge flap 130 can include more irregular structures such as a sharp edge transitioning to a Krueger flap structure.

Any suitable element or structure can be used to mate the leading edge flap segments when either stowed or deployed. Generally, the portions of the leading edge flaps at the junction can be formed so that the edges of each have similar shape, thereby reducing or eliminating structural discontinuity at the junction.

FIGS. 9A, 9B, and 9C depict side, front, and top views of a supersonic aircraft 800 that employs an airfoil capable of improving aircraft performance by facilitating positive aerodynamic effects including adjustment of flow fields to improve aerodynamics at a range of air speeds and maintaining a low sonic boom signature. Aircraft 800 comprises a fuselage 802 and wing 804 coupled to fuselage 802. Wing 804 has a leading edge 806 that extends from an inboard edge at fuselage 802 to an outboard edge at the wing tip. The airfoil further comprises a strake 808 that couples wing 804 to fuselage 802 and extends to leading edge 806 of wing 804. Krueger flap 810 couples to leading edge 806 adjacent strake 808. Similarly, leading edge flap 812 couples to leading edge 806 and extends from junction 814 along the leading edge of winglet 816. As the Mach cone angle moves farther aft the higher the lift is carried vertically, dihedral raises the height of the wing as one goes outboard. However, too much dihedral makes the aircraft roll during sideslip. To maximize the height of the wing for sonic boom minimization without saturating roll control during sideslip, the wing should have higher inboard dihedral and an anhedraled wing tip. As shown in FIG. 9B, winglet 816 takes advantage of its greater moment arm to counter the roll from greater inboard dihedral. By making greater inboard dihedral controllable, this anhedraled winglet improves sonic boom minimization Additionally, winglet 816 typically outboard of the fuel extent allowing the fuel bearing portion of the wing 808 to be flat or dihedraled easing pumping fuel, and allows movement as a control surface. This much smaller, lower sweep outboard winglets 816 works without negatively impacting fuel volume and bending loads as much.

Aircraft 800 contains a control systems that adjust the leading edge control surfaces of the wings 804 to improve aerodynamic flow fields for flight at Mach numbers different from the Mach number to which the aircraft design is optimized, reduce vortex and trim drag, reduce the sonic boom signature of the aircraft while at supersonic cruise conditions, and provide a measure of roll or directional control. Additionally, the leading edge control surfaces may be used in conjunction with trailing edge device 818 to reduce drag at subsonic cruise conditions.

In the illustration shown, aircraft 800 has engines 820 positioned in aft locations beneath wings 804 and have a highly integrated wing/inlet geometry 822 to produce low-boom compatibility and low inlet/nacelle installation drag. As shown, aircraft 800 has an inverted V-tail geometry 824 that generates low-sonic-boom longitudinal trim in cruise and structural support for the engines 820.

Aircraft 800 has an elongated nose 828 with nose tip 830 and inverted V-tail surface 824 that overlaps wing 804. These features facilitate low-sonic-boom aircraft performance. The configuration suppresses a sonic boom pressure waveform that otherwise amplify the sound of the sonic boom. Rapid pressure rises at the front and rear of the pressure wave produce the characteristic double explosion of the sonic boom. These pressure rises are ameliorated in the illustrative design by various structural and operational improvements including the wing leading edge structures and control techniques described herein.

Tip 830 can create a pressure spike ahead of the aircraft forward shock, raising local temperature and sound velocity, thereby extending the forward shock and slowing the pressure rise. Supersonic aircraft 800 has a sharply swept arrow wing configuration that reduces peak overpressure in the wave by spreading wing lift along the aircraft length. The wing configuration has reduced wing leading and trailing edge sweeps.

Aircraft 800 has twin non-afterburning turbofan engines 820 set below and behind wing 804. The non-afterburning turbofan engines depicted operate behind simple fixed-geometry axis-symmetric external compression inlets 832. Other engines may be used in other embodiments. Considerations of community noise and takeoff, transonic, and cruise thrust specifications determine engine cycle selection and engine sizing.

The shape of supersonic aircraft 800 integrates wing 804, tail assembly 834, and engines 820 to provide a reduced sonic boom signature and improved supersonic cruise drag considerations. Empennage or tail system 834 includes stabilizers, elevators, and rudders in inverted V-tail geometry 824. Inverted V-tail geometry 824 supports nacelles 836 in highly suitable positions relative to wing 804 to suppress supersonic-booms, and trim supersonic aircraft 800 to attain an improved low-boom lift distribution. Panels of the inverted V-tail 824 support nacelles 836 and non-afterburning turbofan engines 820 and combine with support from wing 804 to handle flutter. Inverted V-tail control surfaces, termed ruddervators 838, adjust aircraft longitudinal lift distribution throughout the flight envelope to maintain a low boom, low drag trim condition.

Fuselage 802, wing 804, and empennage 834 integrate with the entire aircraft configuration in order to achieve a low-boom signature and supersonic cruise drag levels. Wing 804 and/or fuselage 802 form an airfoil having aerodynamic characteristics appropriate for low-boom supersonic and transonic flight.

As depicted in FIG. 4, the wings can have a substantial dihedral, or “gulling” inboard of the engines. Negative dihedral geometry or anhedral is pronounced at the wing's trailing edge. The gull or dihedral results from twisting and cambering wing 804 for low-boom and low induced drag while preserving a tailored local wing contour in the position of main landing gear retraction.

In some embodiments, the inboard portion of wing 804 can be configured to integrate with nacelle 836 and a diverter formed between nacelle 836 and wing 804 to follow the contour of a low-sonic-boom fuselage 802 with as close a normal intersection as possible to attain low interference drag. In some embodiments, an inboard flap hinge line is fully contained within the wing contour with the wing upper and lower surfaces held as planar as possible to facilitate seal design.

With the resulting wing configuration, the “gull” wing raises engines 820 to increase available tipback angle and reduce thrust-induced pitching moments. Gulling enhances low-boom signature by vertically staggering the wing longitudinal lift distribution and lowers the aircraft body or fuselage 802 to reduce the height of the cabin above the ground, thereby reducing entry stair length. The low fuselage 802 assists in maintaining a low aircraft center of gravity, reducing tipover angle and promoting ground stability. The gull wraps wing 804 around nacelle 836 and enhances a favorable interference between inlets 832 and wing 804, resulting in a wing/body/nacelle geometry conducive to successful ditching and gear-up landings. The anhedral of the outboard winglets increase the ground effect during take of as well as providing positive wave drag interference with the nacelles.

The leading edge surfaces of wing 804, including the leading-edge flap of strake 808, Krueger flap 810, and flap 812 are controlled or directed by one or more control systems to adjust aerodynamic flow fields, thereby improving aerodynamic performance in operation at various airspeeds. The leading edge surfaces can also be controlled to adjust the leading-edge flow field to maintain a low sonic boom signature or to provide roll or directional control.

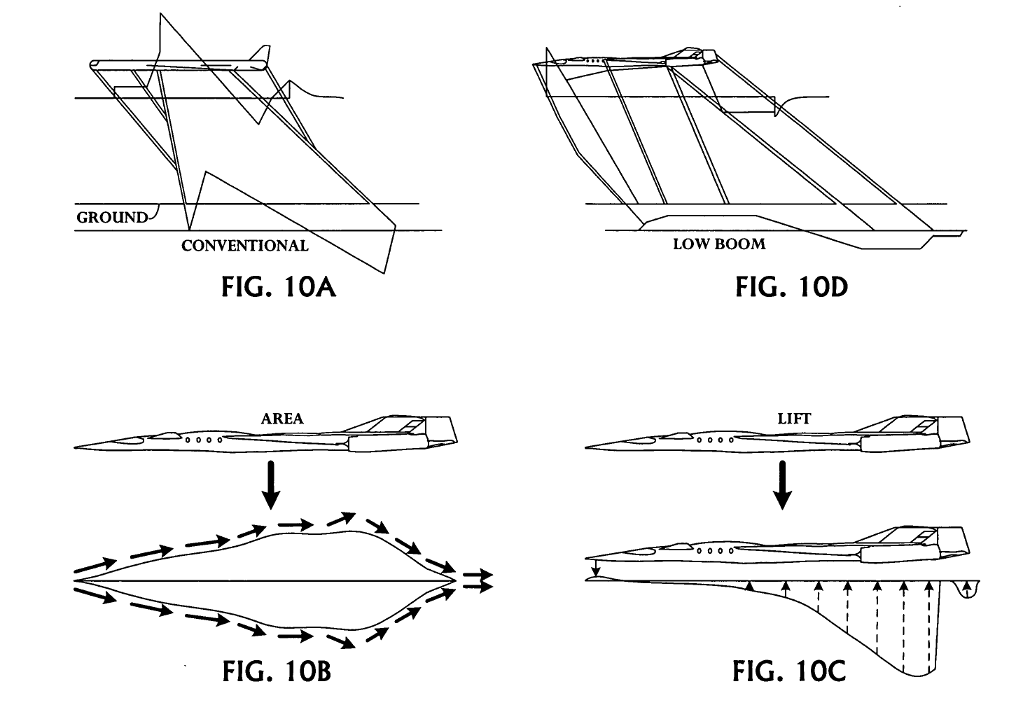

FIGS. 10A, 10B, 10C, and 10D provide a series of graphs that illustrate the theory upon which a low sonic boom signature is attained by controlling the leading edge flaps of the wings 804, reducing sonic boom loudness while maintaining long supersonic range. The leading edge control elements reduce sonic boom loudness by shaping the sonic boom for low shock strengths. FIG. 10A is a graph showing the pressure distribution from a conventional supersonic aircraft. The pressure distribution coalesces into an N-wave at the ground, a shape corresponding to the largest shock strength and thus the greatest loudness. One technique for reducing sonic boom amplitude at the ground involves a minimization theory in which a pressure distribution caused by a low boom aircraft follows an inversely calculated distribution to generate low shock strength at the ground. Contrary to intuition, a low boom distribution occurs when a strong leading edge compression quickly reduces in magnitude, followed by a gradually increasing weak compression that rapidly inverts into a weak expansion, followed by a stronger trailing edge compression that gradually recompresses to ambient. Boom minimization occurs when an aircraft produces an inversely calculated pressure distribution without sacrificing performance. The pressure distribution produced by an aircraft results from a Mach angle, cross-sectional area distribution, for example as shown in FIG. 10B, and a Mach angle lift distribution, as shown in FIG. 10C. The leading edge devices can include the strake leading edge flaps, the Krueger flaps, and the outboard leading edge flaps, individually or in various combinations, operate to shift the lift distribution of the aircraft and shape the active area distribution to reduce sonic boom amplitude at the ground. A minimized pressure distribution, shown in FIG. 10D, occurs when the sum of the area pressure distribution and the lift pressure disturbance equal the minimized pressure distribution. The leading edge devices described herein can be used to shape the pressure distribution.

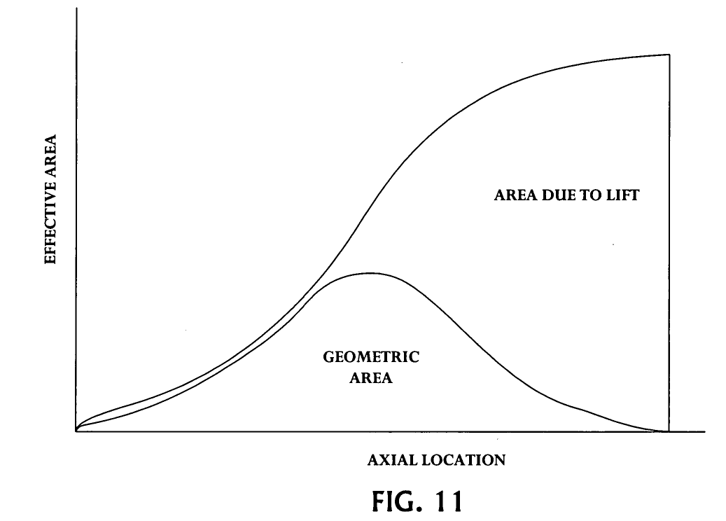

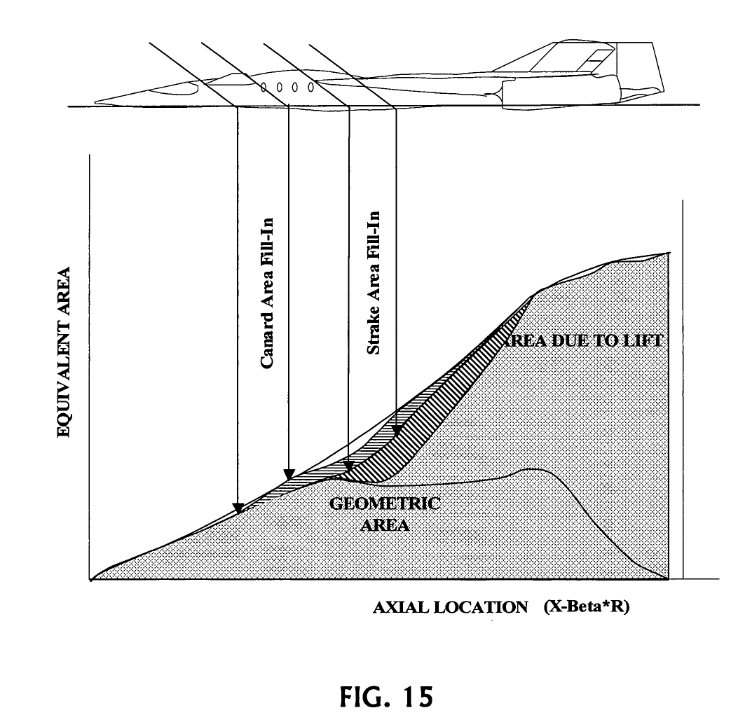

The graph presented in FIGS. 11 and 15 further illustrates the theory of equivalent area minimization to reduce sonic boom signature, showing effective area against axial location along the longitudinal axis of the aircraft. When equivalent area due to geometric area and lift sum to the minimized distribution, a minimized ground sonic boom occurs. The leading edge surfaces are controlled to modify the airflow over wing, 804, stretching the lifting length to move the active area distribution closer to the distribution that shapes the sonic boom signature and maintains a clean flow of air over wing 804, clearing any vortices from wing 804. Accordingly, the leading edge flaps including the flaps of strake, Krueger flaps, and leading edge flaps, can be controlled to create an area distribution for sonic boom shaping to a desired target.

Returning to FIGS. 9A, 9B and 9C, aircraft 800 controls the leading edge control surfaces, including one or more of leading edge flap segments in accordance with an equivalent area technique to reduce sonic boom signature. Equivalent area is the Mach angle area distribution of an axis-symmetric body that generates the same disturbance as a given geometric area or given lift distribution. The equivalent area due to geometric area can be approximated as equal to the Mach angle area distribution. The equivalent area due to lift is equal to the integral of the Mach lift per unit of streamwise length times atmospheric constants.

In the illustrative embodiment, the leading edge control surfaces are controlled to reduce or minimize sonic boom by deflecting the airflow to reduce lift ahead of the spillage due to nacelles 836. For example, if aircraft 800 is flying in an off-design condition in which the nacelles 836 are spilling air and are thus generating stronger shocks and stronger compressions, the leading edge control surfaces and be actuated to compensate by creating an expansion of air flow that blocks the spillage.

The wings and engine are generally designed to operate at various air speeds. Engine 820 and inlet 826 characteristics are configured to coordinate engine airflow schedules and flight Mach number. In a particular embodiment, a fixed geometry inlet 826 can be utilized, for example to reduce propulsion system weight and complexity, and thereby improve efficiency and performance. In particular fixed-geometry inlet configurations, airflow is matched at all pertinent Mach numbers so that no bypass or excessive subcritical spillage occurs under nominal conditions. Airflows at off-nominal conditions can be matched using engine trim and a translating engine cowl.

In one embodiment, an inlet/engine configuration is based on a supersonic aircraft engine that maintains a status range of 3600 nautical miles (nmi) at Mach 1.8. The fixed compression geometry engine inlet is optimized for Mach 1.8. A maximum Mach 1.8 capable design represents performance of the Mach 1.8 -designed engine cruising at Mach 1.6. The Mach 1.8 -capable engine flying at Mach 1.6 increases range and engine life, and potentially improves performance on hot-temperature days.

In an alternative embodiment, an engine 820 is configured with a fixed compression geometry inlet optimized for Mach 1.6, increasing range to approximately 4250 nmi by increasing lift/drag ratio by a full point, and a lower engine weight enabling more fuel to burn in cruise.

Various design techniques can be used to configure an aircraft for a range capability that is greater than a baseline Mach 1.8 point design approach, yet supply a greater speed capability than a Mach 1.6 point design method. One technique is to design a Mach 1.6 inlet and engine and cruise off-design at Mach 1.8 to improve range over a Mach 1.8 design inlet, for example attaining a 150-250 nmi improvement in range. A second technique involves designing the aircraft as a Mach 1.6 point design for maximum range and accepting any over-speed capability that happens to occur, resulting in a small speed increase for a fully optimized Mach 1.6 engine design that is further limited by engine life reduction as well as degradation of inlet stability and distortion. In a slight variation to the second approach, the engine can be configured as a Mach 1.6 point design with the engine and subsystem design Mach numbers tailored to any speed a Mach 1.6 inlet is capable of attaining in an over-speed condition. The range benefit is even smaller than the effect of a pure Mach 1.6 aircraft but the over-speed capability can be improved although not to the level of a Mach 1.8 design. A third approach incorporates a variable geometry inlet into an otherwise Mach 1.8 configuration so that efficient on-design inlet performance can be obtained from a range from Mach 1.6 to Mach 1.8, resulting in a small range penalty due to higher weight and higher losses inherent to the variable geometry inlet. Mach 1.6 performance of the third approach is further hindered due to increased inlet weight.

In a fourth approach, the inlet design Mach number is set such that a Mach 1.8 cruise can be attained in an over-speed condition with engine, subsystem, and aerodynamic design configured to maximize range at Mach 1.6. The illustrative concept does not operate on-design in a purest sense, although enabling the largest range of a fixed compression geometry inlet capable of cruising at Mach 1.8. Potentially, flight at a lower than design Mach number using the fixed geometry external compression engine and translating engine cowl can increase spillage drag and integrate the inlet and propulsion system in a manner that results in a higher drag.

An illustrative aircraft 800 can have inlets, engines, and an airframe generally designed for Mach 1.8 performance, and further includes optimizations to improve various performance aspects. The configuration enables cruising at a slightly lower Mach number than 1.8 to attain a higher range performance. In an illustrative embodiment, the wings are sized slightly larger than normal for a Mach 1.8 design to improve takeoff and landing performance.

The control elements operating the leading edge flap of strake 808, Krueger flap 810, and leading edge flap 812 can be controlled to further facilitate operation of aircraft 800 at off-design Mach numbers.

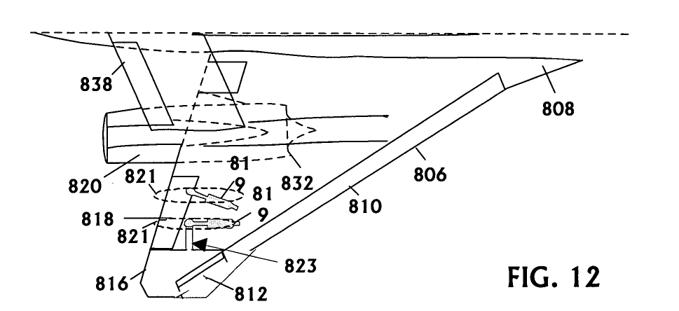

FIG. 12 employs winglet 816 having an anhedral of about 30 degrees, typically outboard of the fuel extent. The resulting winglet's closer proximity to the ground intensifies the ground effect increasing lift, reducing drag and resulting in improved take-off performance. Further, George-Seebass-Darden minimization requires the aircraft lift to be carried aft, and because the Mach cone angle moves farther aft the higher the lift is carried vertically, dihedral raises the height of the wing as one goes outboard. Too much dihedral can make the aircraft roll during sideslip. To maximize the height of the wing for sonic boom minimization without saturating roll control during sideslip, the wing may have a higher inboard dihedral and an anhedraled wing tip. The tip takes advantage of its greater moment arm to counter the roll from greater inboard dihedral. By making greater inboard dihedral controllable, this anhedraled winglet improves sonic boom minimization. In addition, the winglet can capture a little more of the shock wave coming off the nacelle for drag reduction. Additional embodiments may incorporate an all-moving winglet with a rotational axis in the dihedral plane of the wing, to control roll with reduced aeroelastic effectiveness loss. This is especially true when operating supersonically. Such an all-moving winglet also results in less adverse yaw during roll conditions. High reliability actuators, like dual-tandem actuators 819 can be housed in streamwise upper surface wing bulge 821 to avoid interference with winglet 816 and nacelle. Upper surface actuators 819 with hinges located at the lower surface allow large hinge radii on the upper surface, where it is more useful for keeping control surface flow attached. The winglet incidence can be changed with rotation shaft 823 when the Mach number is changed from the design point to maximize drag reduction.

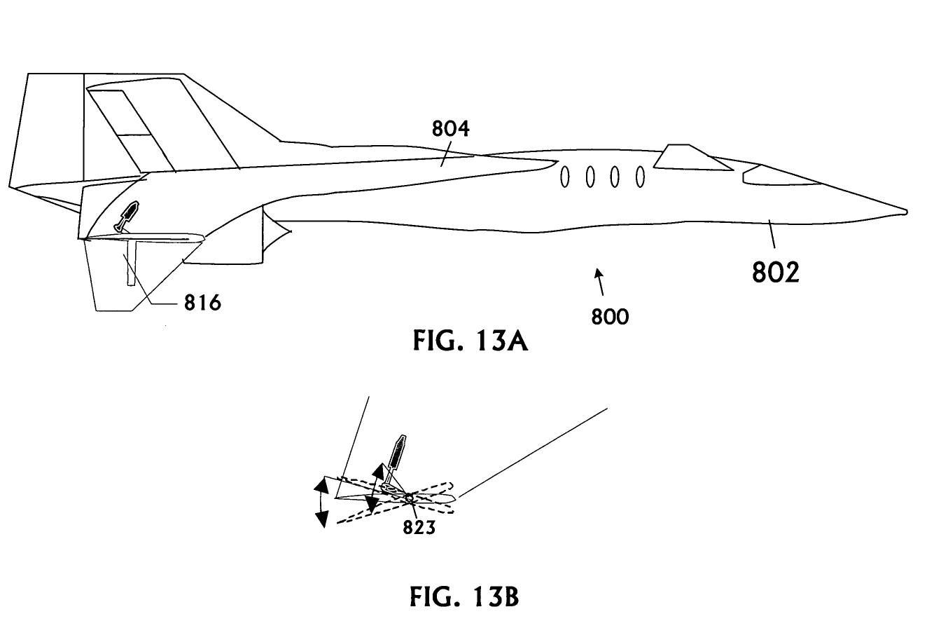

FIGS. 13A and 13B employs a winglet 816 having a dihedral of −60 to −90 or about +90 degrees. This winglet or a portion thereof, through rotation shaft 823 rotates about an axis perpendicular to the plane of the inboard portions of the wing 804. Actuator 819 can be placed in the axis of the wing spars. This embodiment allows increased yaw control from aft placed sideforces, and contributing drag differentials at winglets 816 due to the winglets or a combination of the winglets and ailerons. It could be possible to reduce or eliminate a larger center fin and rudder.

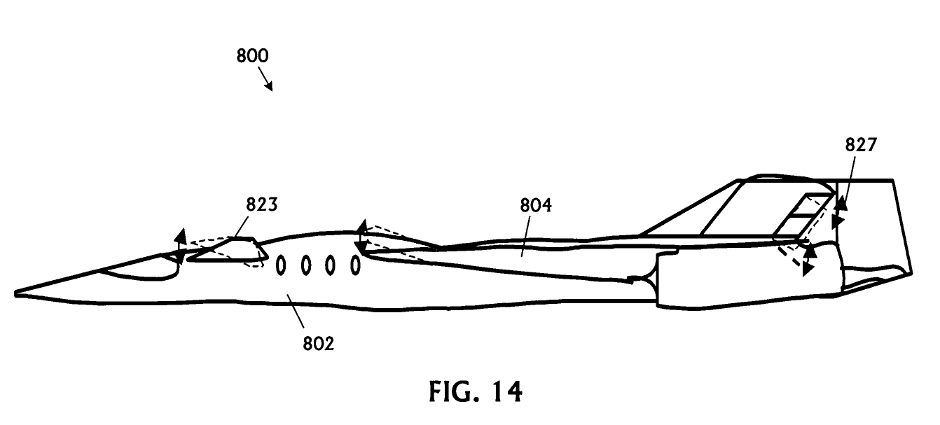

The inboard section of wing 804 may be have a higher leading edge sweep that is adjusted to fill-in the typical dip that occurs in the equivalent area just ahead of the wing. The spanwise extent of this higher swept region may be limited to the first 20 to 30 percent of span where a leading edge flap is not typically needed, to allow for a straighter leading edge flap. This higher inboard sweep can be separate or combined with the previous outboard wing sections. Canard 823 of FIG. 14 can also be used with or without the higher inboard sweep to fill-in the typical dip that occurs in the equivalent area just ahead of the wing.

Wing control surfaces 825, flaps 827, tails and canards 823 can be used to meet sonic boom minimization requirements. By using movable surfaces to alter the lift distribution to meet sonic boom minimization requirements, resulting drag penalties do not have to be incurred wherever low sonic boom is not required, like over water. Since maximum range is generally most important over water, using movable surfaces for sonic boom minimization can reduce the drag penalty associated with reducing sonic boom.

FIGS. 15 and 15A is a graph illustrating the relationship between the equivalent area of the aircraft and the axial location.

Other mission-related characteristics facilitated by control of the leading edge surfaces include a capability to cruise at lower Mach numbers, and a tendency to cruise at lower altitudes at lower Mach numbers, resulting from an optimum lift coefficient occurring at lower altitude as a consequence of lower speed. Furthermore, suitable engines for the desired Mach performance typically produce lower specific fuel consumption at the lower altitudes. Also, lower cruise altitudes yield excess thrust at cruise, enabling a reduction is engine cruise thrust requirement and reduced engine weight. Additionally, lower cruise altitudes allow cruise to begin earlier and end later in a mission so that the aircraft spends proportionately more of a mission in a cruise condition. Also, lower cruise Mach numbers yield lower total air temperatures, benefit engine and subsystem life. Lower cruise Mach numbers can also reduce emissions.

While the present disclosure describes various embodiments, these embodiments are to be understood as illustrative and do not limit the claim scope. Many variations, modifications, additions and improvements of the described embodiments are possible. For example, those having ordinary skill in the art will readily implement the steps necessary to provide the structures and methods disclosed herein, and will understand that the process parameters, materials, and dimensions are given by way of example only. The parameters, materials, and dimensions can be varied to achieve the desired structure as well as modifications, which are within the scope of the claims. Variations and modifications of the embodiments disclosed herein may also be made while remaining within the scope of the following claims.

1. A wing for use on a supersonic aircraft comprising:
an inboard section of the wing adjacent to the fuselage;
a central section of the wing outboard of the inboard portion;
an outboard winglet oriented anhedrally relative to a lateral axis of the supersonic aircraft and outboard of the central section of the wing;
a leading edge formed from leading edge segments on the inboard section, central section and outboard winglet, wherein the leading edge segments have mounted thereon leading-edge flaps; and
a control system operable to reposition the leading edge flaps to improve aerodynamic performance of the supersonic aircraft.

2. The wing of claim 1, wherein the inboard section of the wing is oriented dihedrally relative to the lateral axis of the supersonic aircraft.

3. The wing of claim 1, wherein the leading-edge flap of the central section of the wing comprises a Krueger flap and the leading-edge flap of the outboard winglet comprises a simple leading-edge flap.

4. The wing of claim 1, wherein the outboard winglet increase ground effect during take off.

5. The wing of claim 4, further comprising a nacelle, and wherein the outboard winglet provides positive wave drag interference with the nacelle.

6. The wing of claim 1, wherein the leading edge flap of the outboard winglet provides roll control at supersonic conditions and directional control with proverse roll effects.

7. The wing of claim 1, wherein the wing further comprises trailing-edge flaps on one or more sections, and wherein the leading edge flaps are controlled in conjunction with the trailing edge flaps by the control system to reduce drag at subsonic cruise conditions.

8. The wing of claim 1, wherein the leading edge flaps increase aft lift, reduce trim and vortex drag, and reduce the sonic boom signature of the supersonic aircraft.

9. The wing of claim 1, wherein the control system couples to the leading edge flaps and adjusts the leading-edge flaps to improve aerodynamic flow fields for flight at Mach numbers different from the Mach number to which the aircraft design is optimized.

10. The wing of claim 1, wherein a strake leading-edge flap repositions to deflect or reduce lift ahead of spillage at an off-design condition and maintain a low sonic boom signature.

11. An aircraft wing capable of coupling to an aircraft fuselage and having a leading edge, the wing extending inboard to outboard, comprising:
a strake capable of coupling to the aircraft fuselage and extending to the leading edge of the wing, the strake further comprising a leading-edge flap;
a Krueger flap coupled to the leading edge of an inboard portion of the wing adjacent the strake and having upper and lower surfaces, wherein the strake leading-edge flap operates as a leading-edge device that can be deflected to create an airflow field impinging on the Krueger flap to reduce or eliminate inboard vortices in an upper surface air flow field; and
an outboard winglet having a simple leading edge flap coupled to the leading edge of the outboard winglet, wherein the outboard winglet is anhedrally oriented relative to a lateral axis of the aircraft, and wherein the simple leading edge flap provides roll control and directional control for the aircraft.

12. The aircraft wing of claim 11, wherein the wing and strake form a swept wing that extends at least one sweep angle from the fuselage.

13. The aircraft wing of claim 1, wherein the wing and strake form a swept wing that extends in a plurality of sweep angle segments from the fuselage, the sweep angle of the inboard portion of the wing differs from the sweep angle of the strake and outboard winglet.

14. The aircraft wing of claim 11, wherein the outboard winglet increase ground effect during take off.

15. The aircraft wing of claim 11, further comprising a nacelle, and wherein the outboard winglet provides positive wave drag interference with the nacelle.

16. The aircraft wing of claim 11, further comprising trailing-edge flaps on one or more sections, and wherein the leading edge flaps are controlled in conjunction with the trailing edge flaps by a control system to reduce drag at subsonic cruise conditions.

17. The aircraft wing of claim 1 1, wherein the leading edge flaps increase aft lift, reduce trim and vortex drag, and reduce the sonic boom signature of the supersonic aircraft.

18. The aircraft wing of claim 17, wherein the control system couples to the leading edge flaps and adjusts the leading-edge flaps to improve aerodynamic flow fields for flight at Mach numbers different from the Mach number to which the aircraft design is optimized.

19. An aircraft comprising:
a fuselage;
an aircraft wing coupled to the fuselage and having a leading edge, the wing extending inboard to outboard, and wherein an inboard section of the wing proximate to the fuselage is oriented at a positive dihedral angle relative to a lateral axis of the aircraft;
a strake capable of coupling to the fuselage and extending to the leading edge of the wing;
a Krueger flap coupled to the leading edge of an inboard section of the wing adjacent the strake;
a leading edge flap coupled to the leading edge of the wing and extending outboard from a junction at die Krueger flap; and
an outboard winglet having a simple leading edge flap coupled to the leading edge of the outboard winglet, wherein the outboard winglet is anhedrally oriented relative to the lateral axis of the aircraft, and wherein the simple leading edge flap provides roll control and directional control for the aircraft.

20. The aircraft of claim 19, wherein the wing and strake form a swept wing that extends at a sweep angle from the fuselage.

21. The aircraft of claim 19, wherein the wing and strake form a swept wing that extends in a plurality of sweep angle segments from the fuselage, the sweep angle of the wing differing from the sweep angle of the strake.

22. The aircraft of claim 19, further comprising a control system coupled to one or more of leading-edge flaps, capable of adjusting leading-edge surfaces to improve aerodynamic flow fields for flight at Mach numbers different from the Mach number to which the aircraft design is optimized.

23. A wing for use on a supersonic aircraft comprising:
a wing, wherein the wing further comprises:
an inboard section of the wing adjacent to the fuselage;
a central section of the wing outboard of the inboard portion;
an outboard winglet outboard of the central section of the wing, wherein the outboard winglet's moment from the supersonic aircraft's fuselage allows control surfaces of the winglet to be reduced in size relative to control surfaces inboard of the outboard winglet;
a leading edge formed from leading edge segments on the inboard section, central section and outboard winglet, wherein the leading edge segments have mounted thereon leading-edge flaps; and
a control system operable to reposition the leading edge flaps to improve aerodynamic performance of the supersonic aircraft.

24. The wing of claim 23, wherein the inboard section of the wing is oriented dihedrally relative to the lateral axis of the supersonic aircraft.

25. The wing of claim 23, wherein a sweep angle of the outboard wingler is less than a sweep angle of the central section of the wing.

26. The wing of claim 23, wherein the outboard winglet increase ground effect during take off.

27. The wing of claim 23, wherein the leading edge flaps are repositioned by actuators directed by the control system.

28. The wing of claim 27, wherein a dihedral angle of the inboard section and central section of the wing allows fuel stored within the inboard section and central section to be readily pumped.

29. The wing of claim 28, wherein the outboard winglet has an anhedral angle between about 0° and 90°.

30. The wing of claim 29, wherein leading edge flaps rotate about an axis in the plane of the outboard winglet and normal to a longitudinal axis the supersonic aircraft.

31. The wing of claim 29, wherein the anhedral angle of the outboard winglet allows the dihedral angle of the inboard section and center section of the wing to be increased to minimize a sonic boom signature of the aircraft

32. A wing comprising:
an inboard section of the wing adjacent to the fuselage, wherein the inboard section is swept at a first angle;
a central section of the wing outboard of the inboard portion, wherein the central section is swept at a second angle that is different than the first angle;
an outboard winglet oriented anhedrally relative to a lateral axis of a supersonic aircraft and outboard of the central section of the wing, wherein the outboard winglet is swept at a third angle that is different than the first angle and the second angle; and
leading edge flaps mounted on the central section and the outboard winglet.

33. The wing of claim 32, wherein the inboard section of the wing is oriented dihedrally relative to the lateral axis of the supersonic aircraft.

34. The wing of claim 32, wherein the leading-edge flap of the central section of the wing comprises a Krueger flap and the leading-edge flap of the outboard winglet comprises a simple leading-edge flap.

35. The wing of claim 32, wherein the wing further comprises trailing-edge flaps on one or more sections, and wherein the leading edge flaps are controlled in conjunction with the trailing edge flaps by the control system to reduce drag at subsonic cruise conditions.

36. The wing of claim 32, wherein the wing is coupled to a fuselage of the supersonic aircraft.
